(19) United States
(12) Patent Application Publication
(10) Pub. No.: US 2005/0162706 A1
(43) Pub. Date: Jul. 28, 2005

(54) Network facsimile machine and network facsimile communication method

(75) Inventors: Masashi Eguchi, Joyo-shi (JP); Yoshifumi Tanimoto, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MURATA KIKAI KABUSHIKI KAISHA, Kyoto-shi (JP)

(21) Appl. No.: 11/038,431

(22) Filed: Jan. 21, 2005

(30) Foreign Application Priority Data
Jan. 26, 2004 (JP) 2004-016480

(51) Int. Cl. H04N 1/00

(52) U.S. Cl. 358/442; 358/400

(57) ABSTRACT

A network facsimile machine accepts a transmission instruction of image data from a terminal device. The network facsimile machine presents to a remote device, identification information of the terminal device that carried out the transmission instruction of the image data and acquires destination information as a response. The network facsimile machine transmits information relating to a transmission job of the image data to a terminal device of the acquired destination information.

### BACKGROUND OF THE INVENTION

1. Field of the Invention

The present invention relates to a network facsimile machine and a network facsimile communication method which transmit image data of an original document or the like by Group 3 (G3) facsimile, Internet facsimile or the like in accordance with a transmission instruction from a client Personal Computer (PC) or the like received via a computer network.

2. Description of Related Art

In accordance with a transmission instruction from a client PC or the like received via a computer network, a network facsimile machine transmits image data received along with the transmission instruction by a G3 facsimile communication protocol or an Internet facsimile communication protocol or the like. When the network facsimile machine receives the transmission instruction from the client PC, the network facsimile machine transmits to the client PC that carried out the transmission instruction, a notification indicating that the transmission instruction has been accepted (hereinafter referred to as a “transmission acceptance notification”) and a notification indicating that transmission has been completed (hereinafter referred to as a “transmission completion notification”) . Accordingly, a user of the client PC can grasp the progress of a transmission process.

However, there are cases in which although the transmission instruction has been carried out from the client PC to the network facsimile machine, the transmission completion notification is not returned for a long period of time. That is, when the transmission process cannot be carried out immediately, for example, when a large volume of transmission jobs are accumulated in the network facsimile machine or when a destination is busy during communication, the transmission completion notification is not returned for a long period of time. In such a case, to confirm the transmission completion notification, the user of the client PC is required to stand by the client PC for a long period of time. Until confirming the transmission completion notification, the user of the client PC cannot perform work with other terminal devices. There are also cases in which although the user carried out a transmission instruction from a client PC in an office to the network facsimile machine, due to circumstances such as a sudden business trip, the user does not have time to be on standby in the office until receiving the transmission completion notification. In such cases, the user is required to make a telephone call from outside to the office to ask someone in the office to confirm whether the transmission completion notification has been returned.

A known network facsimile machine accumulates transmitted image data and a transmission result or the like in a Hyper Text Transfer Protocol (HTTP) server. The image data and the transmission result accumulated in the HTTP server can be confirmed from a terminal device having a browser function.

According to the above-described network facsimile machine, by using the browser function from a terminal device different from the client PC that carried out the transmission instruction, a confirmation can be made on whether or not the transmission process is completed. However, the transmission result or the like is registered after the completion of the transmission process of the network facsimile machine. Therefore, there is a drawback that a progress of the transmission process cannot be grasped until the completion of the transmission. The user cannot accurately grasp a reason why the transmission result has not been received yet. For example, the reason may be a plurality of unprocessed transmission jobs being accumulated in the network facsimile machine and the transmission process being in a queue. The reason may be transmission documents including a plurality of pages and a long period of time being required for the transmission. The reason may be a line being busy. Moreover, in case a large number of transmission results are accumulated in the HTTP server, a large amount of time and effort is required for finding a transmission result of an original document on which the transmission instruction has been carried out.

### BRIEF SUMMARY OF THE INVENTION

The present invention has been made in consideration of the above-described circumstances. An advantage of the present invention is to provide a network facsimile machine which enables a terminal device, which is different from a client PC which carried out a transmission instruction, to easily confirm a progress of a transmission process relating to the transmission instruction carried out by the client PC.

According to a first aspect of the present invention, a network facsimile machine presents to a remote device, identification information of a terminal device that carried out a transmission instruction of image data. The network facsimile machine acquires destination information as a response. Then, the network facsimile machine transmits information relating to a transmission job of the image data to a terminal device of the acquired destination information.

According to the first aspect, the information relating to the transmission job of the transmission instruction carried out by the client PC can be confirmed from a terminal device that is different from the client PC which carried out the transmission instruction. Therefore, for example, by setting an electronic mail address of a notebook PC or a mobile phone as the destination information, the user who carried out the transmission instruction from the client PC located in an office can confirm the information relating to the transmission job from outside the office. Moreover, the network facsimile machine acquires the destination information from a remote device. Therefore, the destination information is not required to be stored in the network facsimile machine. Accordingly, storage resources of the network facsimile machine can be saved.

According to a second aspect of the present invention, the information relating to the transmission job includes job specifying information which specifies the transmission job. When receiving from another device, a request designating the job specifying information and requesting the information relating to the transmission job, the network facsimile machine transmits to the terminal device of the destination information, the information relating to the transmission job corresponding to the designated job specifying information.

According to the second aspect, for example, the terminal device of the destination information transmits to the network facsimile machine, electronic mail including received job specifying information (for example, a job number). Accordingly, the terminal device can easily acquire progress information of the transmission job. The job specifying information cannot be learnt by a third party. Therefore, by designating the job, an illegal access by a third party can be prevented.

According to a third aspect of the present invention, the information relating to the transmission job includes job specifying information which specifies the transmission job. When receiving from another device, a request designating the job specifying information and requesting the information relating to the transmission job, the network facsimile machine transmits to the terminal device which carried out the request, the information relating to the transmission job corresponding to the designated job specifying information.

According to the third aspect, for example, the terminal device having a browser function designates to the network facsimile machine, job specifying information (for example, a job number) by HTTP communication. Accordingly, the terminal device can easily acquire progress information of the job corresponding to the job specifying information. The job specifying information cannot be learnt by a third party. Therefore, by designating the job, an illegal access by a third party can be prevented.

### BRIEF DESCRIPTION OF THE SEVERAL VIEWS OF THE DRAWING

FIG. 1 is a block diagram showing an example of a structure of a network facsimile machine according to an embodiment of the present invention.

FIG. 2 is a flowchart showing a processing operation carried out when the network facsimile machine receives a transmission instruction from a client PC according to an embodiment of the present invention.

FIG. 3 is a flowchart showing processes carried out between each of devices when the client PC carries out a facsimile transmission instruction to the network facsimile machine.

FIG. 4 shows an example of a correspondence table of a notification destination (destination information).

FIG. 5 is a flowchart showing processes carried out by the network facsimile machine at a completion of a transmission job according to an embodiment of the present invention.

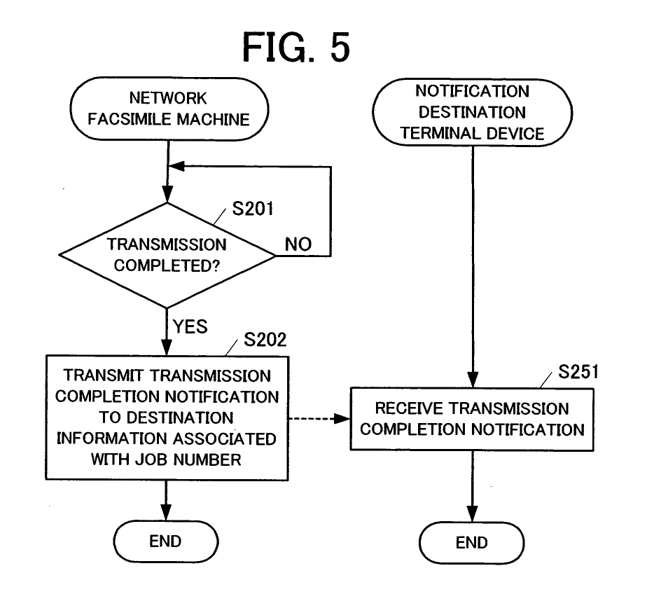

FIG. 6 is a flowchart showing processes carried out between a notification destination terminal device and the network facsimile machine when a Uniform Resource Locator (URL) written in a transmission acceptance notification is designated.

FIG. 7 is a flowchart showing processes carried out by the network facsimile machine when the notification destination terminal device transmits electronic mail including a job number to the network facsimile machine.

### DETAILED DESCRIPTION OF THE INVENTION

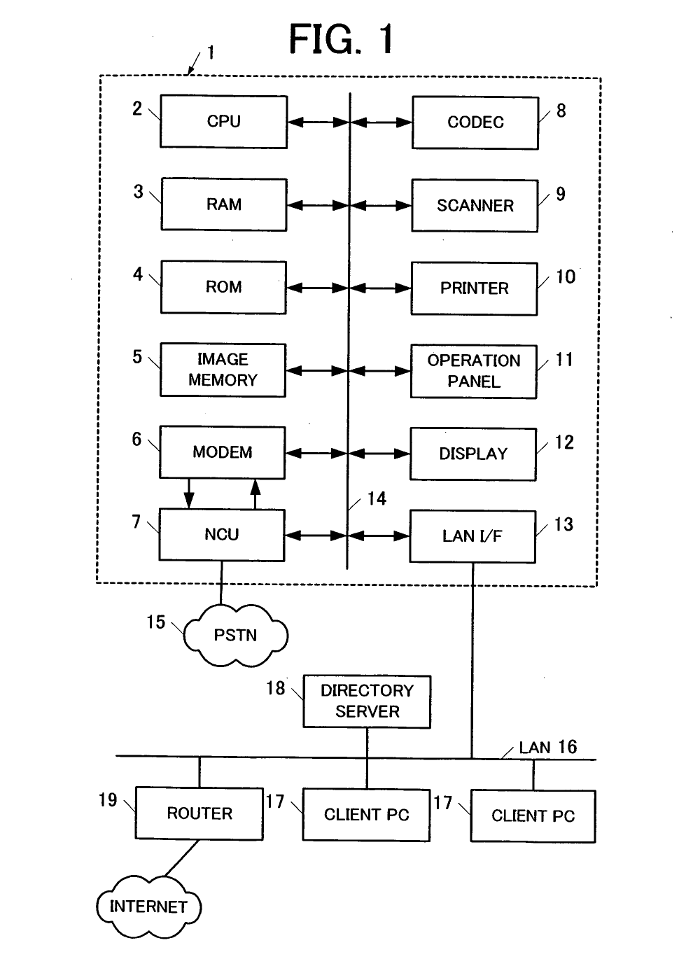

With reference to the drawings, a network facsimile machine according to an embodiment of the present invention will be described. FIG. 1 is a block diagram of a network facsimile machine 1 according to an embodiment of the present invention. The network facsimile machine 1 includes a Central Processing unit (CPU) 2, a Random Access Memory (RAM) 3, a Read Only Memory (ROM) 4, an image memory 5, a modulator-demodulator (MODEM) 6, a Network Control Unit (NCU) 7, a coder-decoder (CODEC) 8, a scanner 9, a printer 10, an operation panel 11, a display 12 and a Local Area Network InterFace (LAN I/F) 13. Each of the units 2 through 13 is connected via a bus 14.

The CPU 2 controls each of the units of the network facsimile machine 1 in accordance with a control program stored in the ROM 4. The RAM 3 functions as a main memory and a working area or the like of the CPU 2. The ROM 4 stores the control program. The image memory 5 accumulates received image data and image data scanned by the scanner 10 or the like.

The MODEM 6 modulates transmission data and demodulates received data in accordance with, for example, the International Telecommunication Union-Telecommunications (ITU-T) Recommendation V.34 standard or anything similar to this. The NCU 7 controls a telephone line to make and disconnect a telephone call. The NCU 7 is connected to a Public Switched Telephone Network (PSTN) 15. The CODEC 8 encodes and decodes image data. That is, for transmitting image data of an original document scanned by the scanner 9, the CODEC 8 encodes the image data in accordance with the Modified Huffman (MH), Modified Read (MR) scheme or the like. The CODEC 8 decodes image data received from a remote device.

The scanner 9 scans an image of an original document. For example, the scanner 9 includes a Charge Coupled Device (CCD) color line sensor, an Analog-to-Digital (A/D) converter and an image processor or the like. The printer 10 carries out an image forming process of the received image data or the like onto printing paper. For example, the printer 10 is an electrophotographic printer. The operation panel 11 includes an input key or the like for a user to input information. The user carries out various operations from the operation panel 11. The display 12 is, for example, a Liquid Crystal Display (LCD) provided in proximity to the operation panel 11. The display 12 displays various pieces of operation information. The LAN I/F 13 connects the network facsimile machine 1 and a LAN 16 in a manner that communication can be carried out.

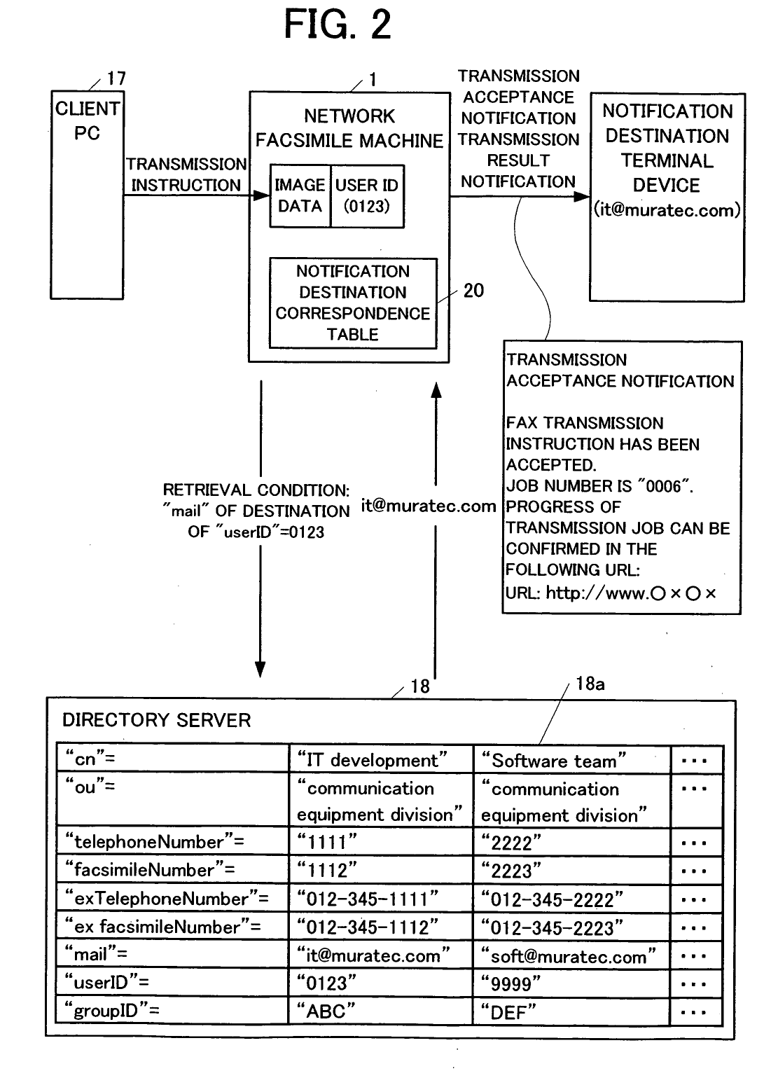

For example, a client PC 17, a directory server 18 which provides a directory service and a router 19 or the like are connected to the LAN 16. The directory server 18 includes a directory management database 18a, an example of which is shown in FIG. 2. Attribute information such as “cn”, “ou”, “telephoneNumber”, “facsimileNumber”, “exTelephoneNumber”, “ex facsimileNumber”, “mail”, “userID” and “groupID” are registered in the database 18a.

The network facsimile machine 1 accesses the database 18a by a Lightweight Directory Access Protocol (LDAP) or the like and acquires various pieces of registered information. In the database 18a shown in FIG. 2, a name of a department is registered by being associated with “cn”. A name of a division of a company is registered by being associated with “ou”. A telephone number is registered by being associated with “telephoneNumber”. A facsimile number is registered by being associated with “facsimileNumber”. An external telephone number is registered by being associated with “exTelephoneNumber”. An external facsimile number is registered by being associated with “ex facsimileNumber”. An electronic mail address is registered by being associated with “mail”. A user ID of the client PC 17 is registered by being associated with “userID”. An ID of a group to which the client PC 17 belongs is registered by being associated with “groupID”.

The above-described network facsimile machine 1 includes a G3 facsimile communication function, an Internet facsimile communication function (a mail server function) and a web server function or the like. The network facsimile machine 1 also includes a communication server function. According to the communication server function, in accordance with a transmission instruction received from the client PC 17, the network facsimile machine 1 transmits to a designated destination by facsimile or Internet facsimile, image data received along with the transmission instruction.

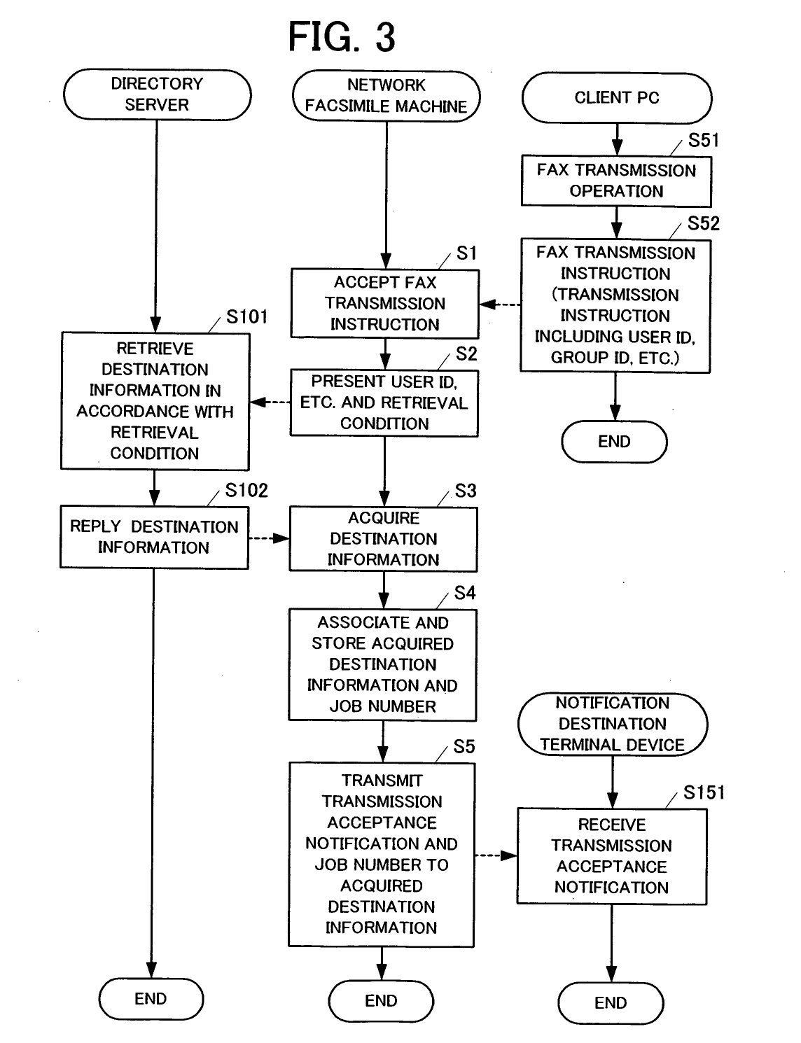

With reference to FIGS. 2 and 3, a description will be made of processes carried out when the network facsimile machine 1 receives the transmission instruction from the client PC 17. Further, the processes of the network facsimile machine 1 to be described with reference to FIGS. 2 and 3 are carried out in accordance with an instruction generated by the CPU 2 based on the control program stored in the ROM 4.

As shown in FIGS. 2 and 3, a user of the client PC 17 carries out a transmission operation for a facsimile transmission (not limited to the facsimile transmission and can be Internet facsimile transmission. Same as above) to be carried out from the network facsimile machine 1 (step S51). The client PC 17 carries out a facsimile transmission instruction to the network facsimile machine 1 (step S52). The transmission instruction is carried out by transmitting to the network facsimile machine 1, a facsimile transmission request instruction, image data, destination information of a transmission destination and a user ID of the client PC or the like.

In the present embodiment, the user ID is raised as an example of the information for specifying the transmission instruction. If the information can specify the transmission instruction, the information can be another physical address such as a group ID and an Internet Protocol (IP) address. In that case, a corresponding group ID or the like is registered as attribute information in the database 18a of the directory server 18.

When the network facsimile machine 1 accepts a transmission instruction (step S1), the network facsimile machine 1 presents to the directory server 18, which is a remote device, the user ID of the client PC 17 acquired along with the transmission instruction, and a retrieval condition (step S2).

The retrieval condition requests destination information (for example, an electronic mail address) of all of destinations including the user ID of the client PC 17 acquired along with the transmission instruction at step S1. The directory server 18 that received the retrieval condition retrieves the database 18a with the user ID designated by the network facsimile machine 1 as an object of a retrieval process (step S101). The directory server 18 replies to the network facsimile machine 1, the destination information (for example, an electronic mail address) registered with each object as a retrieval result (step S102).

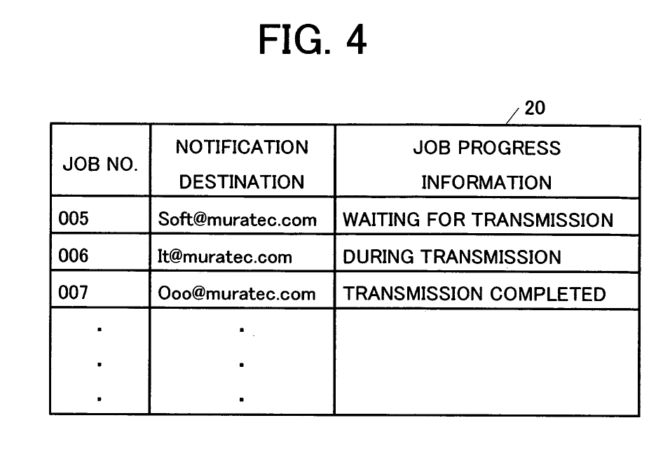

The network facsimile machine 1 acquires the destination information as the response from the directory server 18 (step S3). Then, the network facsimile machine 1 associates and stores the acquired destination information (a notification destination) and the transmission job number in a notification destination correspondence table 20 shown in FIG. 4 as an example (step S4). Further, the transmission job number is a transmission job number relating to the transmission instruction accepted at step S1. The network facsimile machine 1 stores (manages) transmission job progress information updated appropriately according to a progress by associating with each job number. The transmission job number can be job specifying information which specifies the transmission job in the network facsimile machine 1. The transmission job number is not limited to a number format described in the present embodiment.

Next, as a notification of information indicating the acceptance of the transmission instruction (hereinafter referred to as a “transmission acceptance notification”), which is information relating to the transmission job of the image data accepted along with the transmission instruction at step S1, the network facsimile machine 1 generates electronic mail including a message indicating the acceptance of the transmission instruction. Then, the network facsimile machine 1 transmits the electronic mail to a terminal device of the acquired destination information (a notification destination) (steps S5 and S151). The electronic mail also includes the transmission job number and a URL for accessing the network facsimile machine 1.

As described above, according to the network facsimile machine 1, the transmission acceptance notification is carried out to the destination information (for example, an electronic mail address) registered along with the user ID in the database 18a of the directory server 18. Therefore, the user can freely set a terminal device for receiving the notification.

When the transmission job relating to the transmission instruction accepted at step S1 has been completed, in other words, when the transmission process of the accepted image data has been completed (step S201: YES), as a notification of information indicating the completion of the transmission process (hereinafter referred to as a “transmission completion notification”), the network facsimile machine 1 generates electronic mail including a message indicating the completion of the transmission process. Then, the network facsimile machine 1 transmits the electronic mail to the terminal device of the destination information corresponding to the job number of the job in the notification destination correspondence table 20 (steps S202 and S251). The electronic mail also includes the job number and a URL for accessing the network facsimile machine 1. Further, the job number and the URL included in the electronic mail transmitted at step S202 are also notified by the transmission acceptance notification. Therefore, the job number and the URL can be omitted in the transmission completion notification.

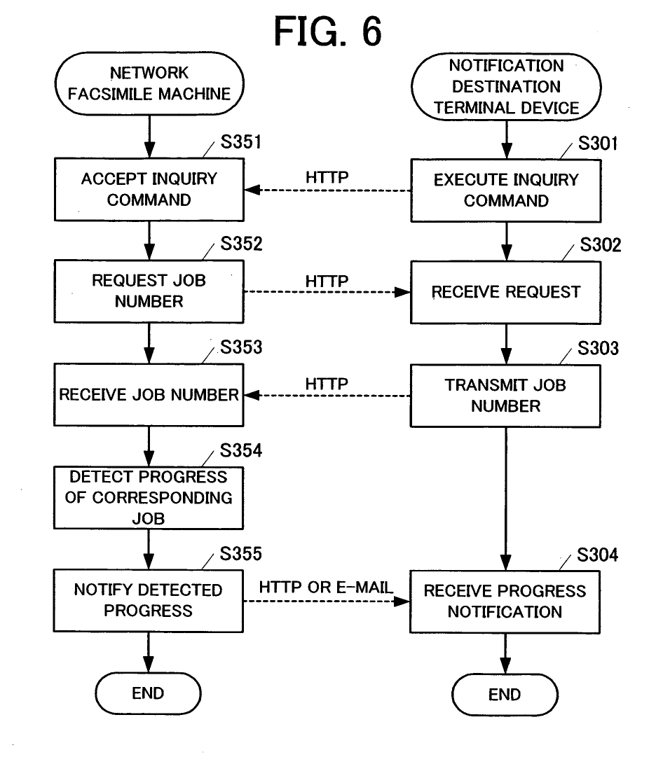

Next, as shown in FIG. 6, when a user of the terminal device that received the transmission acceptance notification and the transmission completion notification accesses the URL included in the received electronic mail via the browser, an inquiry command is executed (step S301). The network facsimile machine 1 assigned to this URL accepts the inquiry command (step S351). By transmitting a Hyper Text Markup Language (HTML) text for displaying screen information to request a job number, the network facsimile machine 1 requests the job number to the terminal device that issued the inquiry command (steps S352 and S302). The terminal device that received the HTML text displays a job number requesting screen. The displayed screen shows a message urging an input of a job number. The user of the terminal device inputs a job number and carries out an operation for transmitting the job number to the network facsimile machine 1. Accordingly, the input job number is transmitted to the network facsimile machine 1 and progress information of a corresponding transmission job is requested (steps S303 and S353).

The network facsimile machine 1, which received the designation of the job number, retrieves job progress information corresponding to the received job number from the notification destination correspondence table 20 (step S354). The job progress information is, for example, information indicating “waiting for transmission”, information indicating “during transmission” and information indicating “transmission completed”. The network facsimile machine 1 notifies the retrieved job progress information to the terminal device (steps S355 and S304). The notification is carried out by transmitting an HTML text which includes the retrieved job progress information. However, electronic mail including the job progress information can be generated and transmitted to the destination information stored by being associated with the job number.

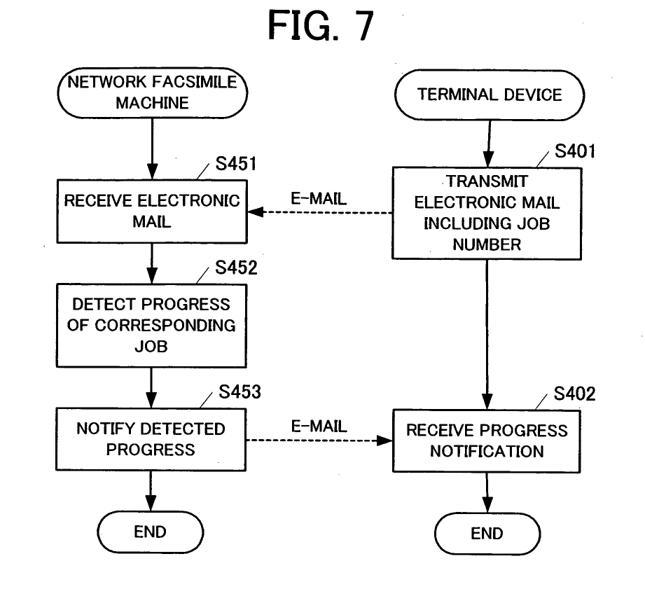

Meanwhile, as shown in FIG. 7, the terminal device or the like of the destination information that received the transmission acceptance notification or the like transmits to the network facsimile machine 1, electronic mail including the job number notified in the transmission acceptance notification or the like (steps S401 and S451). When the job number included (designated) in the electronic mail corresponds with the job number issued in the network facsimile machine 1, the network facsimile machine 1 assumes that the received electronic mail is electronic mail requesting the progress information of the transmission job. The network facsimile machine 1 detects from the notification destination correspondence table 20, the job progress information corresponding to the job number included (designated) in the received electronic mail (step S452). For example, the job progress information is information indicating “waiting for transmission”, information indicating “during transmission” and information indicating “transmission completed”. The network facsimile machine 1 generates electronic mail including the detected job progress information. The network facsimile machine 1 transmits the electronic mail to the destination information stored by being associated with the job number. Accordingly, the job progress information, which is the information relating to the transmission job, is notified (steps S453 and S402).

As described above, according to the network facsimile machine 1 of the present embodiment, the progress of the transmission job relating to the transmission instruction carried out by the client PC can be confirmed from a terminal device that is different from the client PC that carried out the transmission instruction. Accordingly, for example, a user who carried out the transmission instruction from a certain client PC 17 can receive the transmission completion notification at another terminal device having an electronic mail function (for example, a notebook PC or a mobile phone of the user). Moreover, by transmitting electronic mail including the job number included in the transmission completion notification to the network facsimile machine 1, the progress information of the transmission job can be acquired easily.

The electronic mail of the transmission acceptance notification and the transmission completion notification or the like includes a URL for accessing the progress information of the network facsimile machine 1. Therefore, if a terminal device includes a browser function, the terminal device can easily confirm the progress information of the transmission job by accessing the URL.

The network facsimile machine 1 acquires from the directory service, the electronic mail address or the like of the destination of the transmission completion notification. Therefore, the electronic mail address or the like is not required to be stored in the network facsimile machine 1. Accordingly, a capacity of the storage resource of the network facsimile machine 1 necessary for storing the electronic mail address or the like can be saved. In case of a user such as a company having a plurality of network facsimile machines 1, the plurality of the network facsimile machines 1 can share the destination information of the electronic mail address or the like registered in the database 18a of the directory server 18. Therefore, load for managing the destination information is reduced.

1. A network facsimile machine, comprising:
means for accepting a transmission instruction of image data from a terminal device;
means for presenting to a remote device, identification information of the terminal device that carried out the transmission instruction of the image data and acquiring destination information as a response; and
means for transmitting information relating to a transmission job of the image data to a terminal device of the acquired destination information.

2. The network facsimile machine according to claim 1, further comprising:
means for generating electronic mail including information relating to the transmission job; and
means for transmitting the generated electronic mail.

3. The network facsimile machine according to claim 1, further comprising:
means for generating for the accepted transmission instruction, job specifying information that specifies the transmission instruction; and
means for transmitting the job specifying information to the terminal device of the destination information.

4. The network facsimile machine according to claim 3, further comprising:
means for receiving from another terminal device, a request of the information relating to the transmission job including the job specifying information;
means for retrieving a progress of a job corresponding to the job specifying information; and
means for transmitting to the other terminal device, the retrieved progress of the job.

5. The network facsimile machine according to claim 4, further comprising:
means for receiving electronic mail; and
means for extracting the job specifying information from the received electronic mail.

6. The network facsimile machine according to claim 4, further comprising:
means for generating electronic mail including the progress of the job; and
means for transmitting the generated electronic mail.

7. The network facsimile machine according to claim 6, wherein the electronic mail is generated and the generated electronic mail is transmitted at a completion of a facsimile transmission job.

8. The network facsimile machine according to claim 4, further comprising:
means for receiving electronic mail;
means for extracting the job specifying information from the received electronic mail;
means for generating electronic mail including the progress of the job specified by the job specifying information; and
means for transmitting the generated electronic mail.

9. The network facsimile machine according to claim 4, further comprising:
means for transmitting by a Hyper Text Transfer Protocol (HTTP) according to the request from the other terminal device;
means for receiving the job specifying information by the HTTP from the other terminal device;
means for generating a Hyper Text Markup Language (HTML) text including the progress of the job corresponding to received job specifying information; and
means for transmitting the generated HTML text by the HTTP.

10. The network facsimile machine according to claim 1, wherein the remote device is a directory server.

11. A network facsimile communication method, comprising the steps of:
accepting a transmission instruction of image data from a terminal device;
presenting to a remote device, identification information of the terminal device that carried out the transmission instruction of the image data and acquiring destination information as a response; and
transmitting information relating to a transmission job of the image data to a terminal device of the acquired destination information.

12. The network facsimile communication method according to claim 11, further comprising the steps of:
generating electronic mail including the information relating to the transmission job; and
transmitting the generated electronic mail.

13. The network facsimile communication method according to claim 11, further comprising the steps of:
generating for the accepted transmission instruction, job specifying information that specifies the transmission instruction; and
transmitting the job specifying information to the terminal device of the destination information.

14. The network facsimile communication method according to claim 13, further comprising the steps of:
receiving from another terminal device, a request of the information relating to the transmission job including the job specifying information;
retrieving a progress of a job corresponding to the job specifying information; and
transmitting to the other terminal device, the retrieved progress of the job.

15. The network facsimile communication method according to claim 14, further comprising the steps of:
receiving electronic mail; and
extracting the job specifying information from the received electronic mail.

16. The network facsimile communication method according to claim 14, further comprising the steps of:
generating electronic mail including the progress of the job; and
transmitting the generated electronic mail.

17. The network facsimile communication method according to claim 16, wherein the electronic mail is generated and the generated electronic mail is transmitted at a completion of a facsimile transmission job.

18. The network facsimile communication method according to claim 14, further comprising the steps of:
receiving electronic mail;
extracting the job specifying information from the received electronic mail;
generating electronic mail including the progress of the job specified by the job specifying information; and
transmitting the generated electronic mail.

19. The network facsimile communication method according to claim 14, further comprising the steps of:
transmitting by a Hyper Text Transfer Protocol (HTTP) according to the request from the other terminal device;
receiving the job specifying information by the HTTP from the other terminal device;
generating a Hyper Text Markup Language (HTML) text including the progress of the job corresponding to the received job specifying information; and
transmitting the generated HTML text by the HTTP.

20. The network facsimile communication method according to claim 11, wherein the remote device is a directory server.
